(19) United States
(12) Patent Application Publication
(10) Pub. No.: US 2010/0138330 A1
(43) Pub. Date: Jun. 3, 2010

(54) METHOD AND ARRANGEMENT FOR DETERMINING VARIABLE BILLING INFORMATION FOR CONTENT AS A COMMUNICATION SERVICE

(76) Inventors: Hans-Georg Baumgarten, Munchen (DE); Hans Rohnert, Muchen (DE)

Correspondence Address: STAAS & HALSEY LLP, SUITE 700, 1201 NEW YORK AVENUE, N.W., WASHINGTON, DC, 20005, US

(21) Appl. No.: 12/449,321

(22) PCT Filed: Nov. 8, 2007
(86) PCT No.: PCT/EP2007/062051

§ 371 Date: Dec. 23, 2009

(30) Foreign Application Priority Data
Feb. 1, 2007 (DE) 10 2007 005 126.5

(51) Int. Cl. G06Q 30/00; G06Q 10/00; G06Q 50/00

(52) U.S. Cl. 705/34; 705/400; 705/418

(57) ABSTRACT

In a criterion module, variable billing information for content stored in a storage module in the communications network is formed in accordance with specified criteria. These criteria can be, for example, the age of the content, the distance of the subscriber terminal from the relevant location of location-related content, or the number of subscriber terminals to which the content is transmitted. This variable billing information is then transmitted via a communications module to a billing system. A substantial advantage of the method and the system relates to the fact that the charges for content transmitted via communications networks to subscribers can be billed according to variable criteria in a flexible way.

### CROSS REFERENCE TO RELATED APPLICATIONS

This application is based on and hereby claims priority to PCT Application No. PCT/EP2007/062051 filed on Nov. 8, 2007 and German Application No. 10 2007 005 126.5 filed on Feb. 1, 2007, the contents of which are hereby incorporated by reference.

### BACKGROUND OF THE INVENTION

Nowadays, communication services are no longer handled solely via traditional communication networks, such as, for instance, the circuit-switched telephone network. Rather, other correspondingly equipped networks, such as e.g. data networks or even return-channel-enabled cable TV networks or quite generally the internet, are also being used to an increasing extent. The term “communication network” is therefore used in the following quite generally for all networks via which communication services are provided and handled.

In a data network, the billing of communication services requires the network operator to determine the usage of the network by all end subscribers. The corresponding usage data is then processed in order to raise a bill for the terminal devices of the end subscribers. Billing of this kind can be carried out in communication networks as well as quite generally in data networks.

In a communication network, the billing and accounting models of the respective communication network operator are used. The switching centers calculate the billing items for all calls and other communication services that have been used in the communication network. The billing items provided by the switching centers are then collected and processed further. The further processing takes place centrally so that an end subscriber bill can be raised. The billing items are often collected by a mediation system which to some extent also has the capability to process billing items of resellers of communication services. As soon as all the billing items have been collected and converted into a common format, the bills can be raised for the end subscribers.

Services delivered to the terminal devices via the communication network have hitherto been billed or charged to the end subscriber at a standardized price that has been fixed on a one-time basis.

A method and an arrangement for billing usage-based communication between a group of wireless terminal devices are known from the publication document WO2006012263A1. A billing system records the direct communication of the wireless terminal devices within the group and determines billing information on the basis of predefined criteria. Such criteria can include, for example, the number of terminal devices in the target group that are involved in the communication or the duration of the talk time.

The patent specification EP1461900B1 discloses a system and method for billing based on the reported traffic load in a packet-oriented telecommunications network. The system includes at least one Media Gateway Control Function that sends a reported traffic load for the Media Gateway Control Function in a registration message to an instant messaging server. Users that subscribe to a load-based billing service also register with the instant messaging server. The instant messaging server sends the reported traffic load to the users in a message whenever the traffic load is updated by the Media Gateway Control Function, and to a billing system when the user places a call. The billing system initially determines a billing rate based on the reported traffic load and finally calculates a charge for the call based on the determined billing rate and the duration of the call.

### SUMMARY

One potential object is to improve the pricing structure within the framework of the billing of communication services.

The inventors propose a method for determining billing information in a communication network, characterized in that
content (con) is stored in a memory module (MEM) in the communication network (NET),
variable billing information (geb-var) for the content (con) is generated by a criteria module (KRIT-MOD), and
the variable billing information (geb-var) is reported to a billing system (GEB-SYS) by a communication module (KOM).

The inventors also propose a system for determining billing information in a communication network, comprising
a content delivery system (CON-SERV) for delivering content (con) to a subscriber terminal device (TEG) via the communication network (NET),
a memory module (MEM) of the content delivery system (CON-SERV) for storing content (con),
a criteria module (KRIT-MOD) for determining variable billing information (geb-var), and
a communication module (KOM) for reporting the variable billing information (geb-var) to a billing system (GEB-SYS) and delivering the content (con) to a subscriber terminal device (TEG) via the communication network (NET).

A significant advantage of the proposed method and system relates to the fact that content that is delivered to subscriber terminal devices via communication networks can be billed in a flexible manner in accordance with variable criteria. This is achieved by determining variable billing information in a criteria module as a function of specific criteria. These can be, for example, the age of the content to be delivered, the distance of the subscriber terminal device from the location of relevance of location-related content or the number of subscriber terminal devices to which the content is delivered.

### BRIEF DESCRIPTION OF THE DRAWING

These and other objects and advantages of the present invention will become more apparent and more readily appreciated from the following description of the preferred embodiments, taken in conjunction with the accompanying drawing of which:

FIG. 1 is a schematic representation showing the components of an arrangement for implementing the method proposed by the inventors.

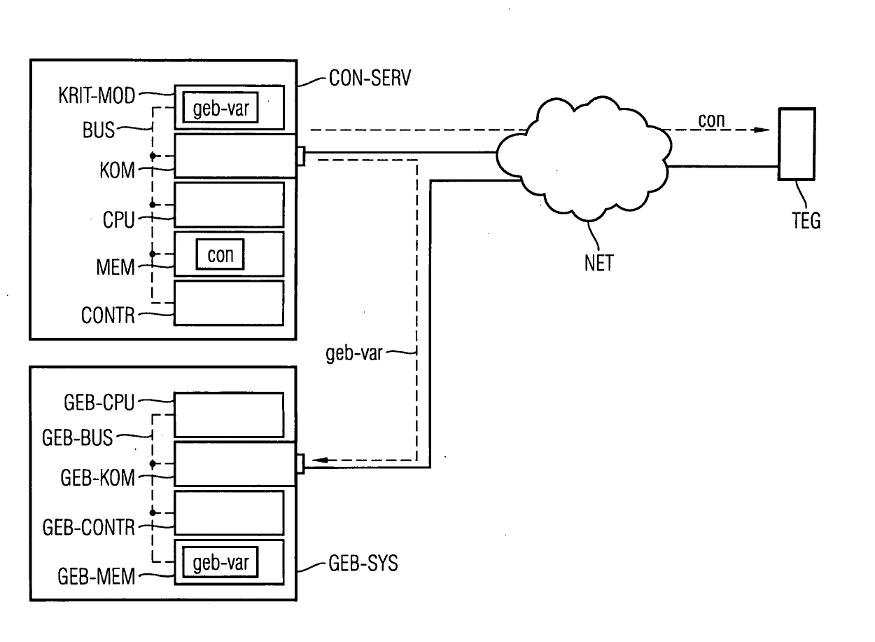

### DETAILED DESCRIPTION OF THE PREFERRED EMBODIMENT

Reference will now be made in detail to the preferred embodiments of the present invention, examples of which are illustrated in the accompanying drawing, wherein like reference numerals refer to like elements throughout.

The arrangement has a communication network NET, a communication services delivery system CON-SERV, a billing system GEB-SYS, and subscriber terminal devices TEG. One subscriber terminal device TEG is shown by way of example.

The communication services delivery system CON-SERV comprises the following components: A memory module MEM, a criteria module KRIT-MOD, and a communication module KOM. The components are connected to one another via a data bus BUS using a corresponding communication protocol.

Using a network-specific communication protocol, e.g. the internet-specific IP protocol, the communication services delivery system CON-SERV (via the communication module KOM), the billing system GEB-SYS and the subscriber terminal device TEG can be connected to one another via the communication network NET.

The communication network NET can be, for example, a circuit- or packet-switched communication network, a mobile radio communication network or a cable TV network appropriately equipped with return channel capability. The communication services delivery system CON-SERV is advantageously a server-based data storage system having a corresponding memory MEM, a processor CPU, a controller component CONTR, and a communication module KOM. The communication services delivery system CON-SERV is advantageously configured in such a way that data-intensive communication services—such as e.g. high-resolution digitized video signals—can also be stored.

The usage of the communication network NET—i.e. the calls placed and possibly further supplementary features or add-on services—is determined for each subscriber terminal device TEG by the billing system GEB-SYS, which is implemented for example as a server system, processed by appropriate accounting software and billed to the end subscribers (not shown).

The billing system GEB-SYS has a processor GEB-CPU, a communication component GEB-KOM, a controller component GEB-CONTR, and a memory GEB-MEM. The components are in this case connected to one another using a corresponding communication protocol, such as the IP protocol, via the communication bus GEB-BUS.

The first exemplary embodiment relates to the generation of variable billing information geb-var for a content con as a function of its age; in other words, therefore, the period of time that lies between the content con being provided for delivery to subscriber terminal devices TEG for the first time and a specified later time. However, the age of a content con can also be defined with regard to its first transmission to a subscriber terminal device TEG or with regard to an event to which the content con relates.

After ordering information has been transferred to the communication module KOM of the communication services delivery system CON-SERV by a subscriber terminal device TEG—the variable billing information geb-var is reported to the billing system GEB-SYS in the course of the usage of the service, e.g. at the beginning or at the end.

In most cases a content con is most attractive when it is new. Thus, for example, a feature film on DVD is more expensive to rent when it is new. However, there are also cases in which the content con is initially provided free of charge and only becomes subject to a charge later. Thus, for example, many newspapers or other organs of the press initially make their articles available at no cost. After a certain time all or selected articles then become subject to a charge.

In the exemplary embodiment, a set of discrete age levels can be defined in the criteria module KRIT-MOD. Examples of such age levels, which relate to the period of time between first publication of a content con and a specific, subsequent time, can be: 1 hour old, 6 hours old, 1 day old, 2 days old, 1 week old, 1 month old, older. Each of these age levels can then be assigned a specific value by the KRIT-MOD via the variable billing information geb-var. Advantageously it is possible in this case not only for the value of the variable billing information geb-var to increase as the age of the content con increases, but also for the value to decrease according to the increasing age of the content con. Alternatively, arbitrary values can be assigned to the different age levels via the variable billing information geb-var.

An advantageous development of the method provides the definition of a quasi-continuous function for generating the variable billing information geb-var. With each time unit that the content con ages, a specific initial or starting value of the variable billing information geb-var is increased or reduced by a specific unit, advantageously until a predefined end value is reached.

The thus determined variable billing information geb-var is then made available by the criteria module KRIT-MOD via the data bus BUS and the communication module KOM by way of the communication network NET to the billing system GEB-SYS via its communication component GEB-KOM (shown in the FIGURE by a dashed arrow labeled geb-var). The variable billing information geb-var is then stored in the billing system GEB-SYS in the memory GEB-MEM. When the call data is subsequently processed for accounting purposes, the variable billing information geb-var is retrieved and used for raising the bill for the subscriber.

In the second exemplary embodiment, the variable billing information geb-var is determined by the criteria module KRIT-MOD as a function of the geographical location of the subscriber terminal device TEG or of the geographical point of reference of the content con. In this case the value of the variable billing information geb-var can be determined by the criteria module KRIT-MOD as a function of how far, for example, the subscriber terminal device TEG is from a defined location of the content con. Thus, a traffic congestion alert, say, can be of most interest when the subscriber terminal device TEG is neither too close to the congestion—since the subscriber is then no longer in a position to react to the traffic congestion alert anyway—nor too far away from it—a traffic jam in southern Germany is of no interest to a subscriber in eastern Germany.

Moreover, the model described in the first exemplary embodiment can also be applied here using discrete levels. Thus, in this exemplary embodiment, each distance level can be assigned a value of the variable billing information geb-var. Similarly, a quasi-continuous function can be defined if the value continuously increases or decreases with distance.

In one embodiment the location of the content con can be defined geographically. Thus, a film, for instance, can be set in one location even though it was shot at another location. The film “Munich”, for example, was shot in Budapest. The location of the content con is Budapest in this case. The location of relevance for the content, on the other hand, is different therefrom in this example; it is Munich. In that respect Munich is the point of reference for a distance-related generation of the variable billing information geb-var for the content con.

According to the proposal, the following criteria, for example, are provided in relation to the geographical assignment of the content in the criteria module KRIT-MOD: The location
1. of the creation of a content con,
2. of the first delivery of a content con, and
3. of the geographical context to which a content con relates.

In a variant of the exemplary embodiment, the broadcasting of, say, the frequently won German premier soccer league championship at Marienplatz, Munich's central square, is of greater interest to citizens of Munich than to residents of other German cities. Accordingly, the variable billing information geb-var can be assigned a higher value in Munich than outside Bavaria.

In a further variant of this exemplary embodiment, a content con which contains information about the latest weather conditions is of no interest for the location at which the subscriber currently finds himself with his subscriber terminal device TEG. In contrast, a subscriber will more likely be interested in a content con providing information about the latest weather conditions at another, more distant location. As a rule a subscriber will only be interested in details of the weather at his current location if it concerns, not the current weather, but a weather forecast for the future. Weather information for the current location may, though, also be of interest, for instance if a subscriber does not have an outside thermometer and wants to know the current outside temperature in order to dress accordingly. All these cases can be registered and handled by the corresponding definition of a function for generating the variable billing information geb-var.

In a third and final exemplary embodiment, the variable billing information geb-var is determined as a function of the number of subscriber terminal devices TEG to which the content con has so far been delivered. In this exemplary embodiment the criteria module KRIT-MOD executes a counting function which determines how often a specific content con has already been transmitted to subscriber terminal devices. The value of the variable billing information geb-var can then be made dependent on the reading of this counter. Scenarios are conceivable in which the value decreases the more frequently a content con has already been transmitted. Thus, it is to some extent particularly desirable to be one of the first subscribers to receive a specific content con. The attractiveness of the content con decreases continually or discretely with the number of subscriber terminal devices TEG to which the content con has already been delivered. Conversely, a content con can evolve from leading an outsider existence into an insider tip or even an especially popular content con. Content con of this kind becomes more attractive as the number of subscriber terminal devices TEG increases—the growth in demand also increases the value of the variable billing information geb-var.

For the purpose of determining the variable billing information geb-var by the criteria module KRIT-MOD, in the case of content con which assists an end subscriber in an action (e.g. travel information, reservation, navigation services, or management services for appointments calendar and meetings), the billing criteria can be derived from the assessment of the relevance of the options for action that can be derived from the content con and are still open to the end subscriber in the case of possible problems. An example of this is the traffic congestion referred to hereintofore, wherein the distance information “distance from the jam” is used indirectly to derive a billing model on which the relevance for the use of detours is based.

In one embodiment, such trends in user behavior are forecast by the criteria module KRIT-MOD. In the first case (declining value) this may still be predictable given a known scenario (announced and much-hyped major international film). The value model for the variable billing information geb-var will be specified in advance accordingly.

In the second case (increasing demand) the prediction is less simple. For that reason the criteria module KRIT-MOD should continuously monitor and analyze the counter reading with regard to the download statistics. If demand increases analogously to a predefined curve, the value of the variable billing information geb-var will be updated in accordance with a function depending thereon.

All the above features of the three exemplary embodiments (age, location, number of consumers) can be combined in order to generate variable billing information geb-var. In this case each feature is advantageously assigned a weight and the variable billing information geb-var is determined from the weighting.

In one embodiment the above methods can all be automated to the extent that a value model can be calculated and proposed on the basis of rudimentary specifications (“value declines continuously with age”, “value increases with number of consumers”, etc.). Advantageously, however, the proposal will then be presented with all the parameters to a decider, so that a possibly less useful model can be corrected again by targeted interventions.

A significant aspect in the handling of such content con as communication services between a provider and an end subscriber is the provisioning of the variable billing information geb-var by the provider in the manner of a communication before the end subscriber makes use of a service.

Should changes in billing rates occur relatively infrequently compared with the typical usage duration of the service, one proposed method entails the interruption of the service and the announcement of a change to the variable billing information geb-var, wherein the end subscriber is given the opportunity to acknowledge the change in billing rate, as a result of which the service is resumed.

Another possibility is the dynamic real-time announcement of the dynamically changing variable billing information geb-var if the service is delivered one piece at a time (in time, volume or content units, for example) with variable billing information geb-var currently assigned to the individual pieces in each case. According to the inventors' proposal, the user is in this case given the option to interrupt the piecewise usage of the service after the announcement of the change to the variable billing information geb-var.

A further possibility is that for the end subscriber who decides to make use of a service, the variability of the variable billing information geb-var is switched off or limited to fixed limit values for the duration of the planned usage of the service. In this case the announcement of the variable billing information geb-var is sufficient as part of the conclusion of the sales agreement.

The variable billing information geb-var or the billing limit value is then stored on a subscriber-specific basis in a memory area provided for that purpose in the memory GEB-MEM of the billing system GEB-SYS.

The invention is neither limited to the exemplary embodiments nor restricted to use in communication networks, but can be deployed in all types of data networks, such as, say, also in the cable TV network or other broadcast networks. It is suitable for applications in all data networks in which there is a requirement to enable variable pricing structures for content.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-20. (canceled)

21. A method for determining billing information in a communication network, comprising:
storing content in a memory module in the communication network;
determining variable billing information for said content by a criteria module; and
reporting said variable billing information to a billing system by a communication module.

22. The method as claimed in claim 21, wherein the variable billing information is determined by the criteria module based on criteria in relation to
the content, and/or
identity of an end subscriber, and/or
subscriber terminal device information.

23. The method as claimed in claim 21, wherein the variable billing information is determined by the criteria module as a function of
time when delivery of the content commenced, and/or
time when delivery of the content terminated, and/or
duration of content delivery, and/or
length of communication time associated with the content, and/or
data volume of the content.

24. The method as claimed in claim 21, wherein the variable billing information determined by the criteria module decreases or increases in stages or continuously as a function of time or age information.

25. The method as claimed in claim 21, wherein the variable billing information is determined by the criteria module as a function of first location information with regard to the content and/or second location information with regard to a terminal device involved in communicating the content.

26. The method as claimed in claim 25, wherein
the variable billing information is determined as a function of the first location information with regard to the content, and
the first location information with regard to the content is derived from the content itself or is determined from further information with regard to the content.

27. The method as claimed in claim 21, wherein the variable billing information is determined by the criteria module as a function of
number of subscriber terminal devices to which the content has been delivered, and/or
age of the content.

28. The method as claimed in claim 21, wherein the data network is
a communication network, and/or
a packet- or circuit-switched mobile radio communication network, and/or
a fixed-line communication network, and/or
a cable TV network.

29. The method as claimed in claim 21, wherein the content is
audio and/or video data, and/or
traffic information, and/or
image information, and/or
textual information, and/or
location information, and/or
weather information.

30. The method as claimed in claim 21, wherein
the variable billing information is determined by the criteria module by a quasi-continuous function or a discrete gradation.

31. The method as claimed in claim 21, wherein
a pricing model is calculated by the criteria module based on user-specified criteria,
the pricing model used to determine variable billing information, which is proposed to a user, and
the user corrects and activates or deletes said pricing model.

32. The method as claimed in claim 21, wherein
the variable billing information is determined by the criteria module by combining age information, location information, and previous consumer information.

33. The method as claimed in claim 32, wherein the age information, location information, and previous consumer information are weighted differently during the determination of the variable billing information.

34. The method as claimed in claim 21, wherein the content is communication services between a provider and an end subscriber, the variable billing information is provided by the provider in the manner of a communication before a service is used by the end subscriber.

35. The method as claimed in claim 34, wherein
a billing rate for the services changes, and
the service is interrupted when the billing rate changes and a change to the variable billing information is announced.

36. The method as claimed in claim 35, wherein after the end subscriber acknowledges the change in billing rate, as a result of which the service is resumed.

37. The method as claimed in claim 21, wherein in the case where, when content is handled as communication services between a provider and an end subscriber, a service is delivered one piece at a time with variable billing information currently assigned to the individual pieces in each case, the end subscriber is given the option to interrupt the piecewise usage of the service after the announcement of a change to the variable billing information.

38. The method as claimed in claim 21, wherein
the content is communication services between a provider and an end subscriber, and
for the end subscriber who decides to make use of a service, variability of the variable billing information is switched off or limited to a fixed limit value for a planned usage duration of the service.

39. The method as claimed in claim 38, wherein the variable billing information or the fixed limit value is stored on a subscriber-specific basis in a memory area provided for that purpose in a memory of the billing system.

40. A system for determining billing information in a communication network, comprising:
a content delivery system for delivering content to a subscriber terminal device via the communication network;
a memory module provided in the content delivery system for storing the content;
a criteria module for determining variable billing information; and
a communication module for reporting the variable billing information to a billing system and delivering the content to a subscriber terminal device via the communication network.
